(19) United States
(12) Patent Application Publication
(10) Pub. No.: US 2019/0172445 A1
(43) Pub. Date: Jun. 6, 2019

(54) VOICE PROCESSING APPARATUS

(71) Applicant: CASIO COMPUTER CO., LTD, Tokyo (JP)

(72) Inventor: Hiroki Tomita, Tokyo (JP)

(21) Appl. No.: 16/193,163

(22) Filed: Nov. 16, 2018

(30) Foreign Application Priority Data
Dec. 5, 2017 (JP) 2017-233310

(51) Int. Cl. G10L 15/06; G10L 15/22

(52) U.S. Cl. CPC G10L 15/063; G10L 15/02; G10L 2015/0635; G10L 15/22

(57) ABSTRACT

A voice processing apparatus includes a first storage unit which stores a known-word, and a processor. The processor executes a voice recognition process of extracting an unknown-word by executing a voice recognition process on an input voice signal, based on a storage content of the first storage unit, and a storage control process of executing storage control to the first storage unit, wherein the storage control process includes a process of storing, when information of a number of unknown-words which are recognized to be identical, among the extracted unknown-words by the voice recognition process, meets a predetermined condition, a corresponding unknown-word in the first storage unit as a known-word.

### CROSS-REFERENCE TO RELATED APPLICATIONS

This application is based upon and claims the benefit of priority from Japanese Patent Application. No. 2017-233310, filed Dec. 5, 2017, the entire contents of which are incorporated herein by reference.

### BACKGROUND OF THE INVENTION

### 1. Field of the Invention

The present invention relates to a voice processing apparatus.

### 2. Description of the Related Art

In a system of voice recognition, an unknown-word, which is not registered in a voice word dictionary, cannot be recognized. Thus, even if the same content is input repeatedly, the system side cannot recognize the same content unless and until the unknown-word is registered in the dictionary.

In order to improve the recognition rate in this situation, there has been proposed a technique in which an unknown-word portion is detected by using both recognition of continuously spoken words and subword recognition of a phoneme or a syllable, and the unknown-word portion is registered in the dictionary (see, e.g. Jpn. Pat. Appln. KOKAI Publication No. 2004-170765).

### SUMMARY OF THE INVENTION

According to one aspect of the present invention, a voice processing apparatus includes a first storage unit which stores a known-word, and a processor. The processor executes a voice recognition process of extracting an unknown-word by executing a voice recognition process on an input voice signal, based on a storage content of the first storage unit, and a storage control process of executing storage control to the first storage unit, wherein the storage control process includes a process of storing, when information of a number of unknown-words which are recognized to be identical, among the extracted unknown-words by the voice recognition process, meets a predetermined condition, a corresponding unknown-word in the first storage unit as a known-word.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a functional configuration of a voice processing circuit according to an embodiment of the present invention;

FIG. 2 is a flowchart illustrating process contents including voice recognition according to the embodiment; and

FIGS. 3A, 3B and 3C illustrate, in a stepwise manner, rearrangement of recognition results of unknown-words according the embodiment.

### DETAILED DESCRIPTION OF THE INVENTION

Hereinafter, referring to the accompanying drawings, a description will be given of an embodiment in which the present invention is applied to a voice processing circuit which is mounted in a pet robot.

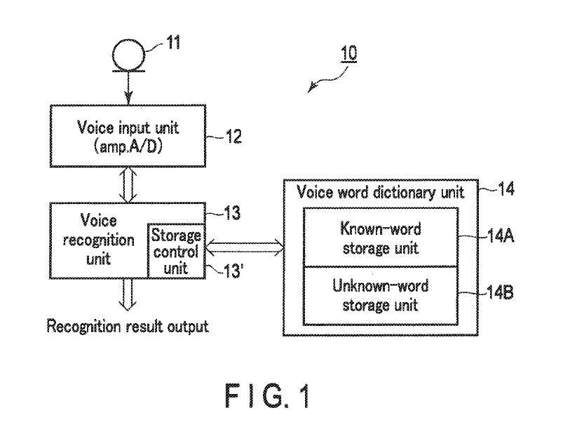

FIG. 1 is a block diagram illustrating, in an extracted manner, a functional configuration of a voice processing circuit 10 according to the present embodiment. In FIG. 1, a voice input unit 12 executes processes, such as amplification and A/D conversion, on an analog voice signal acquired by a microphone 11, thereby converting the analog voice signal to digital data, and the voice input unit 12 outputs the obtained digital data to a voice recognition unit 13.

The voice recognition unit 13 extracts phonemes and syllables by, for example, dynamic programming (DP) matching, and executes voice recognition by referring to a voice word dictionary unit 14. Character data corresponding to the phonemes or syllables, which are a recognition result, is output, as needed, as data corresponding to input voice in an application program which is using this voice recognition process.

The voice word dictionary unit 14 includes a known-word storage unit 14A which stores a phoneme or syllable of voice of a known-word and character data corresponding to the phoneme or syllable, and an unknown-word storage unit 14B which stores a phoneme or syllable of voice of an unknown-word and character data corresponding to the phoneme or syllable.

Note that the above-described voice recognition unit 13 represents, as a circuit block, a voice recognition function which is mounted in an operating system (OS) in, for example, a pet robot. Actually, the voice recognition unit 13 is realized by the execution of the OS by a CPU of the pet robot. Alternatively, the voice recognition unit 13 may be provided as a hardware circuit by a purpose-specific LSI that is independent from the CPU. The voice recognition unit 13 is provided with a storage control unit 13′ which executes storage control to the known-word storage unit 14A and unknown-word storage unit 14B.

Next, an operation of the above-described embodiment will be described.

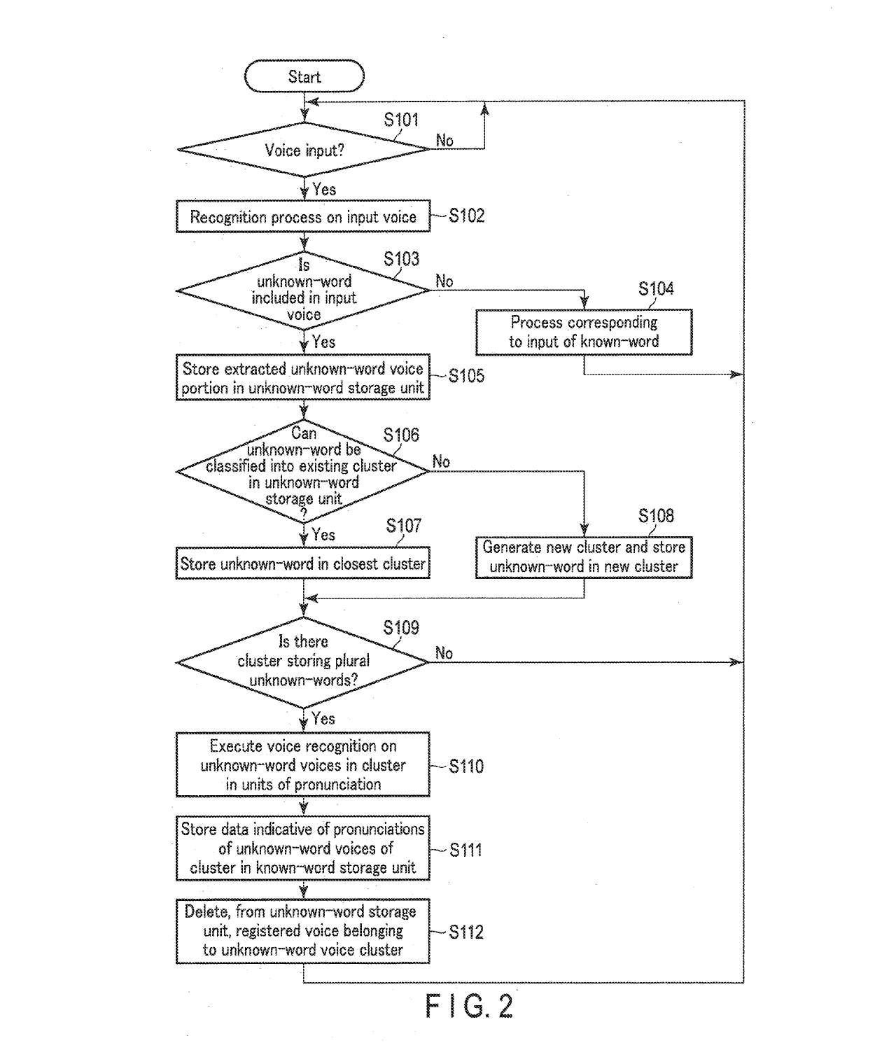

FIG. 2 is a flowchart illustrating process contents including a recognition process for a voice input, the recognition process being executed mainly by the voice recognition unit 13 and storage control unit 13′ under the control of the CPU.

At the beginning of the process, the voice recognition unit 13 repeatedly determines whether voice data is input via the microphone 11 and voice input unit 12 (step S101), thereby standing by for an input of voice data.

When the voice data is input, a person extraction process may be executed to extract a person from image data acquired by a camera unit (not shown) which the pet robot that is equipped with the present voice processing circuit 10 includes, or the microphone 11 may be configured to have an array structure of microphones. Thereby, the direction of a speaker may be estimated, and voice from the estimated direction may be determined to be voice is uttered toward the pet robot.

Then, at a time point when it is determined that voice data from the voice input unit 12 is input (Yes in step S101), the voice recognition unit 13 executes a recognition process for the input voice data (step S102).

The voice recognition unit 13 refers to the known-word storage unit 14A of the voice word dictionary unit 14 and determines whether an unknown-word is included in the result obtained by the recognition (step S103).

At the time of detecting an unknown-word, for example, such existing methods as recognition of continuously spoken words and subword recognition of a phoneme or syllable are executed. One of the recognition results of these methods, which has a higher likelihood in the subword recognition is recognized as an unknown-word.

If no unknown-word is included in recognition results and it is determined that all recognition results can be recognized as known-words (No in step S103), the voice recognition unit 13 executes a prescribed process corresponding to character data of the recognition results by these known-words (step S104) and then returns to the process from step S101 to stand by for the next voice input.

On the other hand, in step S103, if it is determined that at least one unknown-word is included in the recognition results (Yes in step S103), the voice recognition unit 13 extracts character data of a phoneme or syllable of the unknown-word portion, and stores the character data in the unknown-word storage unit 14B of the voice word dictionary unit 14 by the storage control unit 13′ (step S105).

Here, the voice recognition unit 13 calculates a distance of a characteristic amount between the unknown-word to be stored and each of clusters of other a unknown-words which are already stored in the unknown-word storage unit 14B at this time point. Based on whether there is a cluster with the characteristic amount that is within a predetermined distance, the voice recognition unit 13 determines whether the unknown-word to be stored can be classified into the already existing cluster (step S106).

In addition, as regards whether the unknown-word to be stored can be classed into the already existing cluster or not, this may also be determined based on whether the distance between recognition results of subwords or the distance between score strings of maximum likelihood phoneme strings of the respective phoneme likelihoods of the respective frames is a preset threshold or less.

If it is determined that there is a cluster with the characteristic amount that is within a predetermined distance and the unknown-word to be stored can be classified into the already existing cluster (Yes in step S106), the voice recognition unit 13 controls the storage control unit 13′ to store the character data of the phoneme or syllable of the unknown-word in the cluster with the shortest distance of the characteristic amount (step S107).

On the other hand, in step S106, if it is determined that there is no cluster with characteristic amount that is within the predetermined distance and the unknown-word to be stored cannot be classified into the already existing cluster (No in step S106), the voice recognition unit 13 generates a new cluster in the unknown-word storage unit 14B and controls the storage control unit 13′ to store the character data of the phoneme or syllable of the unknown-word in the newly generated cluster (step S108).

Thereafter, the voice recognition unit 13 determines whether a cluster, which stores a plurality of unknown-words, exists in the unknown-word storage unit 14B of the voice word dictionary unit 14 (step S109).

If no cluster, which stores a plurality of unknown-words, exists in the unknown-word storage unit 14B (No in step S109), the voice recognition unit 13 returns to the process from step S101 to stand by for the next voice input.

In step S109, if a cluster, which stores a plurality of unknown-words, exists in the unknown-word storage unit 14B (Yes in step S109), the voice recognition unit 13 executes voice recognition, in units of pronunciation, on the character data of voices of unknown-words in the corresponding cluster in the unknown-word storage unit 14B (step S110).

The voice recognition unit 13 controls the storage control unit 13′ to store, in the known-word storage unit 14A, data indicative of pronunciations of voices of the unknown-words in the corresponding cluster (step S111).

After the unknown-words are registered in the known-word storage unit 14A, the voice recognition unit 13 controls the storage control unit 13′ to delete the data relating to the voices of the unknown-words, which was registered in the known-word storage unit 14A, from the unknown-word storage unit 14B (step S112). Thereafter, the voice recognition unit 13 returns to the process from step S101 to stand by for the next voice input.

After the unknown-words are registered in the known-word storage unit 14A, if the (previous) unknown-word is input, the voice recognition unit 13 calculates, like the process by normal voice recognition, the likelihoods in pronunciations of the known-words stored by registration in the known-word storage unit 14A, and compares the (previous) unknown-word with other words. Thereby, the voice recognition unit 13 can detect that the (previous) unknown-word, which was registered as the known-word, has been spoken to the voice processing circuit 10.

In this manner, contents recognized as unknown-words as results of voice recognition are clustered as needed, and accumulated and stored, and the stored contents are rearranged. Thereby, an unknown-word, which can be determined to have a very short distance of a characteristic amount, compared to other unknown-words, is registered as a known-word. Thereby, the recognition rate in voice recognition of subsequently input similar previous unknown-words can be improved.

In the meantime, in the above-described embodiment, in a state in which no unknown-word is stored in the unknown-word storage unit 14B, when a first unknown-word is stored, the first unknown-word may be stored without generating a cluster. When the characteristic amount of a next extracted unknown-word is similar to the characteristic amount of the first stored unknown-word, the unknown-words may be registered in the known-word storage unit 14A as the known-words. When the characteristic amount of the next extracted unknown-word is not similar to the characteristic amount of the first stored unknown-word, their respective clusters may be generated.

In addition, in the above-described step S109, the voice recognition unit 13 determines whether a cluster, which stores a plurality of unknown-words, exists in the unknown-word storage unit 14B of the voice word dictionary unit 14. Alternatively, the voice recognition unit 13 may determine whether a cluster that stores a number of unknown-words, which is equal to or greater than a preset threshold N, exists in the unknown-word storage unit 14B of the voice word dictionary unit 14. If the cluster that stores a number of unknown-words, which is equal to or greater than the preset threshold N, exists in the unknown-word storage unit 14B, the voice recognition unit 13 may execute voice recognition in step S110, in units of pronunciation, on the character data of voices of the unknown-words in the corresponding cluster in the unknown-word storage unit 14B.

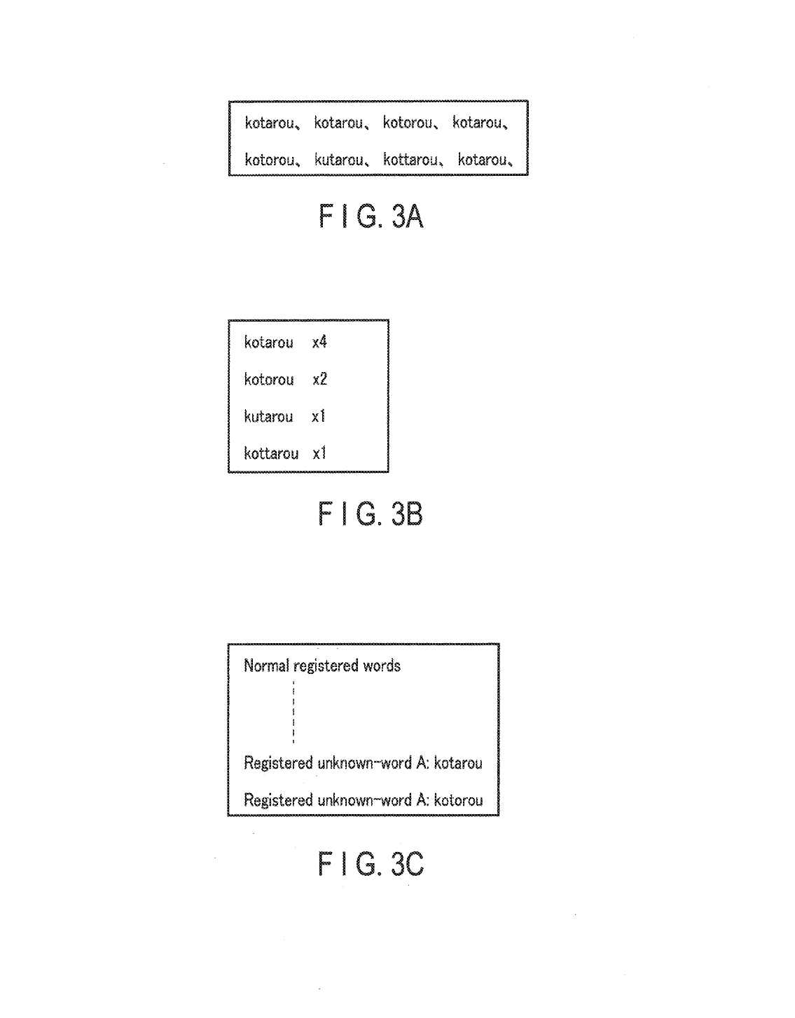

FIG. 3A illustrates eight recognition results including syllables “kotarou” with an edit distance of “1”.When recognition results within this edit distance are included in an identical cluster, it is assumed that all the recognition results are treated as the identical cluster.

FIG. 3B illustrates a result in which the eight recognition results of FIG. 3A are rearranged in units of pronunciation. There are four occurrences of “kotarou”, which occurs most frequently, and there are two occurrences of “kotorou”, which occurs second most frequently.

In step S111, when only the pronunciation of the first rank of the frequency of occurrence is registered (M=1), only “kotarou” is registered in the known-word storage unit 14A. In addition, when the pronunciations of the first and second ranks of the frequency of occurrence are registered (M=2) , both “kotarou” and “kotorou” are registered in the known-word storage unit 14A.

FIG. 3C is a view illustrating a state in which both “kotarou” and “kotorou” that are previous unknown-words are stored as “registered unknown-words A” in the known-word storage unit 14A.

Note that, as character data which the voice recognition unit 13 outputs as results of voice recognition by referring to the known-word storage unit 14A, the recognition results “kotarou” and “kotorou”, which were input, accumulated and stored in the unknown-word storage unit 14B, may be distinguishably converted to character data and the character data may be output.

On the other hand, depending on the setting of the system of the voice processing circuit 10, as regards the contents stored in the same cluster of the unknown-word storage unit 14B, the character data of the first rank in the contents, e.g., “kotarou” may be treated as representative character data. Even if the word having the shortest distance as the registered unknown-word stored in the known-word storage unit 14A “kotorou”, “kotarou” may be output as the recognition result to a rear-stage circuit of the voice recognition unit 13.

In addition, in the above-described step S109, the voice recognition unit 13 may determine whether a cluster, which stores a plurality of unknown-words, exists in the unknown-word storage unit 14B of the voice word dictionary unit 14, at a preset time instant, for example, at a time instant in the midnight when the pet robot would surely be in a non-used state. If a cluster, which stores a plurality of unknown-words, exists in the unknown-word storage unit 14B, the voice recognition unit 13 may execute the processes of step S110 to step S112 at the preset time instant.

According to the present embodiment which was described above in detail, the recognition rate in a case in which voices of similar unknown-words were repeatedly input can be improved.

Additionally, in the above-described embodiment, the process is executed to extract a part of unknown-words with a high input frequency and to register the part of unknown-words as known-words, at a timing corresponding to at least either the total number of unknown-words which are determined to have relatively short distances of a characteristic amount and accumulated and stored in the same cluster, or the preset time instant. By executing the process quantitatively or at fixed time intervals, the contents of the known-word storage unit 14A are updated and stored in accordance with the condition of use of the voice processing circuit 10. Thus, a voice recognition environment, which is optimized for a user who uses the apparatus equipped with the voice processing circuit 10, can be constructed.

Additionally, in the embodiment, an unknown-word, which is to be registered as a known-word, is selected in accordance with the ranking of the frequency of occurrence in the cluster in which unknown-words determined to have relatively short distances of a characteristic amount are accumulated and stored. In addition to this, an absolute value of the frequency of occurrence of an unknown-word that is selected as a known-word may also be set.

In this manner, by making it possible to discretionarily set the selection condition at the time of selecting an unknown-word from among unknown-words and registering the unknown-word as a known-word, a voice recognition environment, which the user has optimized in accordance with the environment of use of the user himself/herself, can be constructed.

Although not described in the above embodiment, in the voice word dictionary unit 14, voice pattern data of a plurality of speakers may be stored. At the time of the voice recognition process which the voice recognition unit 13 executes, speaker recognition may also be executed, and a cluster of unknown-words may be stored on a speaker-by-speaker basis. Thereby, the recognition rate can be further improved at the time of registering an unknown-word as a known-word from among accumulated and stored results of unknown-words.

Additionally, in the embodiment, voice data is stored in the known-word storage unit 14A and unknown-word storage unit 14B of the voice word dictionary unit 14. Alternatively, text data, to which the voice data is converted, may be stored.

Additionally, in the embodiment, unknown-words, which the voice recognition unit 13 extracted, are classified into clusters in accordance with the degree of similarity and stored in the unknown-word storage unit 14B. Based on the number of unknown-words of each of the clusters into which the unknown-words were classified and stored, a corresponding unknown-word is registered in the known-word storage unit 14A as a known-word. Alternatively, unknown-words may not be classified into clusters, and unknown-words, which the voice recognition unit 13 extracted, may be stored in the unknown-word storage unit 14B as such. When the number of unknown-words stored in the unknown-word. storage unit 14B meets a predetermined condition, a corresponding unknown-word may be registered in the known-word storage unit 14A as a known-word.

Additionally, in the embodiment, each time the voice recognition unit 13 extracts an unknown-word, all extracted unknown-words, for instance, “kotarou”, “kotarou”, “kotorou”, “kotarou”, “kotorou”, “kutarou”, “kottarou” and “kotarou”, are stored in the unknown-word storage unit 14B. Alternatively, instead of storing the unknown-words in the unknown-word storage unit 14B, information of the number of unknown-words, in which an extracted unknown-word and the number of times of extraction of the unknown-word are associated, may be managed. This information indicates, for example, that “kotarou” was extracted four times, “kotorou” was extracted two times, “kutarou” was extracted once, and “kottarou” was extracted once.

Additionally, in the embodiment, the unknown-word storage unit 14B, which stores unknown-words extracted by the voice recognition unit 13, is provided. Alternatively, the unknown-word storage unit 14B may not be provided, and, as described above, the information of the number of unknown-words, in which the extracted unknown-word and the number of times of extraction of the unknown-word are associated, may be managed. When the number of times of extraction of an unknown-word meets a predetermined condition, this unknown-word may be registered in the known-word storage unit 14A as a known-word.

Besides, the present invention is not limited to the above-described embodiments. In practice, various modifications may be made without departing from the spirit of the invention. The embodiments can be combined and implemented, and the combined advantages can be obtained in such cases. Furthermore, the above-described embodiments include various inventions, and various inventions can be derived from combinations of structural elements selected from the structural elements disclosed herein. For example, even if some structural elements are omitted from all the structural elements disclosed in the embodiments, if the problem can be solved and advantageous effect can be obtained, the structure without such structural elements can be derived as an invention.

What is claimed is:

1. A voice processing apparatus, comprising:
a first storage unit which stores a known-word; and
a processor,
the processor being configured to execute:
a voice recognition process of extracting an unknown-word by executing a voice recognition process on an input voice signal, based on a storage content of the first storage unit; and
a storage control process of executing storage control to the first storage unit,
wherein the storage control process includes a process of storing, when information of a number of unknown-words which are recognized to be identical, among unknown-words extracted by the voice recognition process, meets a predetermined condition, a corresponding unknown-word in the first storage unit as a known-word.

2. The voice processing apparatus according to claim 1, wherein the storage control process includes a process of classifying, the unknown-words extracted by the voice recognition process is accordance with a degree of similarity, and includes the process of storing, when information of a number of unknown-words which are recognized to be in an identical classification meets a predetermined condition, a corresponding unknown-word in the first storage unit as a known-word.

3. The voice processing apparatus according to claim 1, further comprising a second storage unit,
wherein the storage control process executing storage control to the first storage unit and the second storage unit, and the storage control process includes a process of classifying, the unknown-words extracted by the voice recognition process in accordance with a degree of similarity, and includes the process of storing, successively the classified unknown-words in the second storage unit, and when information of a number of unknown-words which are recognized to be in an identical classification, among the unknown-words classified and stored in the second storage unit, meets a predetermined condition, a corresponding unknown-word in the first storage unit as a known-word.

4. The voice processing apparatus according to claim 3, wherein the storage control process includes the process of storing, when a total number of unknown-words which are recognized to be in an identical classification, among the unknown-words classified and stored in the second storage unit, meets a predetermined condition, a corresponding unknown-word in the first storage unit as a known-word.

5. The voice processing apparatus according to claim 3, wherein the storage control process includes the process of storing, when at least one of an absolute value of a number of unknown-words which are recognized to be in an identical classification, or a number of predetermined upper ranks of unknown-words, among the unknown-words classified and stored in the second storage unit, meets a predetermined condition, a corresponding unknown-word in the first storage unit as a known-word.

6. The voice processing apparatus according to claim 3, wherein the storage control process includes the process of storing, when information of a number of unknown-words which are recognized to be in an identical classification, among the unknown-words classified and stored in the second storage unit, meets a predetermined condition at a preset time instant, a corresponding unknown-word in the first storage unit as a known-word.

7. The voice processing apparatus according to claim 3, wherein the voice recognition process includes a process of recognizing a speaker from input voice information, and
the storage control process includes a process of classifying, the extracted unknown-words, based on a degree of similarity, in accordance with the speaker recognized by the voice recognition process, and includes the process of storing, successively the classified unknown-words in the second storage unit.

8. A. voice processing method for use in a voice processing apparatus that includes a first storage unit which stores a known-word, the method comprising:
a voice recognition step of extracting an unknown-word by executing a voice recognition process on an input voice signal, based on a storage content of the first storage unit; and
a storage control step of executing storage control to the first storage unit,
wherein the storage control step includes a step of storing, when information of a number of unknown-words which are recognized to be identical, among unknown-words extracted by the voice recognition step, meets a predetermined condition, a corresponding unknown-word in the first storage unit as a known-word.

9. The voice processing method according to claim 8, wherein the storage control step includes a step of classifying, the unknown-words extracted by the voice recognition step in accordance with a degree of similarity, and includes the step of stoning, when information of a number of unknown-words which are recognized to be in an identical classification meets a predetermined condition, a corresponding unknown-word in the first storage unit as a known-word.

10. The voice processing method according to claim 8, further comprising a second storage unit,
wherein the storage control step executing storage control to the first storage unit and the second storage unit, and the storage control process includes a step of classifying, the unknown-words extracted by the voice recognition step in accordance with a degree of similarity, and includes the step of storing, successively the classified unknown-words in the second storage unit, and when information of a number of unknown-words which are recognized to be in an identical classification, among the unknown-words classified and stored in the second storage unit, meets a predetermined condition, a corresponding unknown-word in the first storage unit as a known-word.

11. The voice processing method according to claim 10, wherein the storage control step includes the step of storing, when a total number of unknown-words which are recognized to be in an identical classification, among the unknown-words classified and stored in the second storage unit, meets a predetermined condition, a corresponding unknown-word in the first storage unit as a known-word.

12. The voice processing method according to claim 10, wherein the storage control step includes the step of storing, when at least one of an absolute value of a number of unknown-words which are recognized to be in an identical classification, or a number of upper ranks of unknown-words, among the unknown-words classified and stored in the second storage unit, meets a predetermined condition, a corresponding unknown-word in the first storage unit as a known-word.

13. The voice processing method according to claim 10, wherein the storage control step includes the step of storing, when information of a number of unknown-words which are recognized to be in an identical classification, among the unknown-words classified and stored in the second storage unit, meets a predetermined condition at a preset time instant, a corresponding unknown-word in the first storage unit as a known-word.

14. The voice processing method according to claim 10, wherein the voice recognition step includes a step of recognizing a speaker from input voice information, and
the storage control step includes a step of classifying, the extracted unknown-words, based on a degree of similarity, in accordance with the speaker recognized by the voice recognition process, and includes the step of storing, successively the classified unknown-words in the second storage unit.

15. A non-transitory computer-readable storage medium having stored thereon a program causing a computer of a voice processing apparatus including a first storage unit which stores a known-word, to function as:
a voice recognition unit which extracts an unknown-word by executing a voice recognition process on an input voice signal, based on a storage content of the first storage unit; and
a storage control unit which executes storage control to the first storage unit,
wherein the storage control unit stores, when information of a number of unknown-words which are recognized to be identical, among unknown-words extracted by the voice recognition unit, meets a predetermined condition, a corresponding unknown-word in the first storage unit as a known-word.

16. The computer-readable storage medium according to claim 15, wherein the storage control unit classifies the unknown-words extracted by the voice recognition unit in accordance with a degree of similarity, and stores, when information of a number of unknown-words which are recognized to be in an identical classification meets a predetermined condition, a corresponding unknown-word in the first storage unit as a known-word.

17. The computer-readable storage medium claim 15, further comprising a second storage unit,
wherein the storage control unit executes storage control to the first storage unit and the second storage unit, classifies the unknown-words extracted by the voice recognition unit in accordance with a degree of similarity, to successively store the classified unknown-words in the second storage unit, and stores, when information of a number of unknown-words which are recognized to be in an identical classification, among the unknown-words classified and stored in the second storage unit, meets a predetermined condition, a corresponding unknown-word in the first storage unit as a known-word.

18. The computer-readable storage medium according to claim 17, wherein the storage control unit stores, when a total number of unknown-words which are recognized to be in an identical classification, among the unknown-words classified and stored in the second storage unit, meets a predetermined condition, a corresponding unknown-word in the first storage unit as a known-word.

19. The computer-readable storage medium according to claim 17, wherein the storage control unit stores, when at least one of an absolute value of a number of unknown-words which are recognized to be in an identical classification, or a number of upper ranks of unknown-words, among the unknown-words classified and stored in the second storage unit, meets a predetermined condition, a corresponding unknown-word in the first storage unit as a known-word.

20. The computer-readable storage medium according to claim 17, wherein the storage control unit. stores, when information of a number of unknown-words which are recognized to be in an identical classification, among the unknown-words classified and stored in the second storage unit, meets a predetermined condition at a preset time instant, a corresponding unknown-word in the first storage unit as a known-word.

21. The computer-readable storage medium according to claim 17, wherein:
the voice recognition unit recognizes a speaker from input voice information, and
the storage control unit classifies the extracted unknown-words, based on a degree of similarity, in accordance with the speaker recognized by the voice recognition unit, and successively stores the classified unknown-words in the second storage unit.
